(19) United States
(12) Patent Application Publication
(10) Pub. No.: US 2011/0235866 A1
(43) Pub. Date: Sep. 29, 2011

(54) MOTION DETECTION APPARATUS AND METHOD

(75) Inventors: Hisashi ENDO, Saitama-shi (JP); Tetsu Wada, Saitama-shi (JP)

(73) Assignee: FUJIFILM CORPORATION, Tokyo (JP)

(21) Appl. No.: 13/016,833

(22) Filed: Jan. 28, 2011

(30) Foreign Application Priority Data
Mar. 23, 2010 (JP) 2010-066302

(51) Int. Cl. G06K 9/00

(52) U.S. Cl. 382/107

(57) ABSTRACT

Erroneous detection of a moving body in a background region is suppressed. Specifically, the position of one input image of two input images is made to coincide with the position of the other input image so as to eliminate relative positional deviation between the two input images. The amount of residual positional deviation in the thus registered two input images is calculated. The resolution of the two input images is lowered so as to take on a resolution A if the amount of residual positional deviation is greater than a prescribed threshold value d and take on a resolution B if the amount of residual positional deviation is equal to or less than the prescribed threshold value d (resolution A<resolution B). Binary difference image data is generated using the input images of lowered resolution and a motion region is detected from a binary difference image represented by the binary difference image data.

### BACKGROUND OF THE INVENTION

1. Field of the Invention

This invention relates to a motion detection apparatus and method.

2. Description of the Related Art

There are a variety of techniques for performing region detection using images, such as detecting a subject in an image (Japanese Patent Application Laid-Open No. 2007-122101) and finding a discrepancy (an altered portion) between two images (Japanese Patent Application Laid-Open No. 2008-269131).

Processing for detecting motion (a moving body) in an image is available in the art. In motion detection processing, generally use is made of a difference in background or a difference between frames. In detection of a subject (moving body) using the difference between two images, it is required that the still regions (background regions) of the two images used in difference calculation be located at the same position. However, with an image obtained by a non-stationary camera, placing the still regions at the same position is not easy. If there is a discrepancy in the positions of the still regions, a positional deviation in the still regions (background regions) will occur between the two images, a difference (false positive) will occur between the still regions (background regions) and the originally intended detection of the moving body (motion) will be hindered. FIG. 11 illustrates the procedure of conventional motion detection processing by images. After two input images 91 and 92 are positionally registered, a difference image 93 is produced. When images obtained by a non-stationary camera are used, there are instances where differences 93a, 93b (false positives) appear in the still region (background) within the difference image 93, along with image 93c of the moving body, owing to a change in shooting perspective.

### SUMMARY OF THE INVENTION

An object of the present invention is to suppress false positives in a background (stationary object) region.

A motion detection apparatus according to a first aspect of the present invention comprises: an input image data accepting device (means) for accepting input of input image data representing an image within a prescribed imaging target zone obtained by imaging the imaging target zone; a registering device (means) for registering position of one input image of two input images with position of the other input image so as to eliminate relative positional deviation between the two input images, which are represented by two items of input image data accepted by the input image data accepting device; a residual positional deviation amount calculating device (means) for calculating amount of residual positional deviation that remains in the two input images after the images are registered by the registering device; a resolution selecting device (means) for selecting, in accordance with the amount of residual positional deviation, any resolution from among a plurality of resolutions equal to or lower than resolution of the input images; a low-resolution input image creating device (means) for lowering the resolution of the two input images so that they will take on the selected resolution in a case where a resolution lower than the resolution of the input images has been selected by the resolution selecting device; and a motion detecting device (means) for detecting a motion region based upon a difference between the two input images or between two low-resolution input images created by the low-resolution input image creating device.

The first aspect of the present invention also provides a control method suited to the above-described motion detection apparatus. Specifically, the method comprises the steps of: accepting input of input image data representing an image within a prescribed imaging target zone obtained by imaging the imaging target zone; correcting position of at least either one of the two input images so as to eliminate relative positional deviation between the two images, which are represented by two items of input image data accepted; calculating an amount of residual positional deviation that remains in the two input images after the images are registered; selecting, in accordance with the amount of residual positional deviation, any resolution from among a plurality of resolutions equal to or lower than resolution of the input images; lowering the resolution of the two input images so that they will take on the selected resolution in a case where a resolution lower than the resolution of the input images has been selected; and detecting a motion region based upon a difference between the two input images or between two low-resolution input images created.

In accordance with the first aspect of the present invention, a difference can be obtained between two low-resolution input images whose resolutions have been lowered so that they will be lower than the resolution of the input images. Therefore, even if there is a positional deviation in a still region (background), it can be made inconspicuous or eliminated and false positives suppressed. As a result, the accuracy of detection (extraction) of a moving body can be enhanced.

When the amount of residual positional deviation is large, the possibility that false positives will occur in a still region (background) rises. In a case where the amount of residual positional deviation is large, therefore, the occurrence of false positives is suppressed effectively if a relatively low resolution is selected. Conversely, in a case where the amount of residual positional deviation is small, a decline in the accuracy with which the position of a motion region is detected is suppressed by selecting a relatively high resolution (inclusive of a resolution the same as the resolution of the input images). The plurality of resolutions from which a selection is to be made may be two (two stages) or more than two (multiple stages).

In an embodiment, the lowest resolution selected by the resolution selecting device from among the resolutions is the highest resolution capable of accommodating the amount of residual positional deviation, i.e., the maximum resolution at which corresponding points in the two input images having a positional deviation equivalent to the amount the same pixel. If resolution is lowered too much, the accuracy with which a motion region is detected declines. Therefore, by limiting the lowest resolution to the highest resolution capable of accommodating the amount of residual positional deviation (the resolution at which pixels separated by the amount of residual positional deviation become the same pixel), resolution will not be lowered unnecessarily and, hence, an unnecessary decline in the accuracy with which a motion region is detected will be avoided.

The resolution selecting device may select each of a horizontal resolution and a vertical resolution.

Preferably, the motion detection apparatus further comprises a comparing device (means) for comparing the amount of residual positional deviation and a prescribed threshold value. In a case where the amount of residual positional deviation exceeds the prescribed threshold value, the resolution selecting device selects the lower resolution of two resolutions that are lower than the resolution of the input images and that have mutually different values. In a case where the amount of residual positional deviation is equal to or less than the prescribed threshold value, the resolution selecting device the higher resolution of these two resolutions. By using either of the two resolutions, detection of a motion region can be performed at higher speed.

Naturally, it may be arranged to provide a table storing a plurality of resolutions in correspondence with different amounts of residual positional deviation and use one resolution selected in accordance with an amount of residual positional deviation from among the plurality of resolutions. Since a difference image having a resolution lower than necessary is no longer generated, a decline in motion detection accuracy can be minimized.

In an embodiment, the motion detecting device detects the motion region from binarized difference image data obtained by comparing and finding the difference between the two input images or between the two low-resolution input images pixel by pixel, and binarizing the difference found.

A motion detection apparatus according to a second aspect of the present invention comprises: an input image data accepting device (means) for accepting input of input image data representing an image within a prescribed imaging target zone obtained by imaging the imaging target zone; a multiple resolution input image creating device (means) for creating, with regard to a set of two input images represented by two items of input image data accepted by the input image data accepting device, sets of multiple resolution input images having mutually different resolutions equal to or lower than the resolution of the input images; a difference image data generated device (means) for generating, with regard to each set of multiple resolution input images of mutually different resolutions generated by the multiple resolution input image creating device, difference image data for every set of resolution input images based upon a difference in the set of resolution input images; a registering device (means) for registering position of one input image of two input images with position of the other input image so as to eliminate relative positional deviation between the two input images, which are represented by two items of input image data accepted by the input image data accepting device; a residual positional deviation amount calculating device (means) for calculating amount of residual positional deviation that remains in the two input images after the images are registered by the registering device; a difference image data selecting device (means) for selecting any one of the plurality of items of difference image data, which have been generated by the difference image data generating device, in accordance with the amount of residual positional deviation calculated by the residual positional deviation amount calculating device; and a motion detecting device (means) for detecting a motion region from the difference image data selected by the image data selecting device.

The second aspect of the present invention also provides a control method suited to the above-described motion detection apparatus.

In accordance with the second aspect of the present invention, resolution input images having a plurality of resolutions are created beforehand with regard to a set of two input images, and a plurality of items of difference image data are created. Any one of the plurality of items of difference image data having a resolution conforming to the amount of residual positional deviation is selected and a motion region is detected using the selected difference image data. In the second aspect of the present invention as well, a difference can be found between two resolution input images the resolution whereof has been lowered so as to have a resolution lower than that of the input images. As a result, even if positional deviation has occurred in a still region (background), this can be made inconspicuous or eliminated and false positives can be suppressed effectively.

A motion detection apparatus according to a third aspect of the present invention comprises: an input image data accepting device (means) for accepting input of input image data representing an image within a prescribed imaging target zone obtained by imaging the imaging target zone; a registering device (means) for registering position of one input image of two input images with position of the other input image so as to eliminate relative positional deviation between the two input images, which are represented by two items of input image data accepted by the input image data accepting device; an area dividing device (means) for dividing the two input images into a plurality of areas; a residual positional deviation amount calculating device (means) for calculating, for every divided area, amount of residual positional deviation that remains in the two input images after the images are registered by the registering device; a resolution selecting device (means) for selecting, for every divided area, in accordance with the amount of residual positional deviation, any resolution from among a plurality of resolutions equal to or lower than resolution of the input images; a low-resolution input image creating device (means) for lowering the resolution of the divided areas of the two input images so that they will take on the selected resolution in a case where a resolution lower than the resolution of the input images has been selected by the resolution selecting device; a difference image data generating device (means) for generating difference image data for every divided area based upon a difference in corresponding divided areas of the two input images or in the divided areas of the two low-resolution images created by the low-resolution input image creating device; a combining device (means) for generating a single item of difference image data by combining the difference image data, of every divided area, generated by the difference image data generating device; and a motion detecting device (means) for detecting a motion region from the combined difference image data generated by the combining device.

The third aspect of the present invention also provides a control method suited to the above-described motion detection apparatus.

In the third aspect of the present invention, in a manner similar to that of the first and second aspects of the present invention, a difference can be found between two low-resolution input images the resolution whereof has been lowered so as to have a resolution lower than that of the input images. As a result, even if positional deviation has occurred in a still region (background), this can be made inconspicuous or eliminated and false positives can be suppressed effectively. Further, in the third aspect of the present invention, different resolutions can be selected in each of a plurality of divided areas. This prevents a situation in which a resolution input image having a low resolution is obtained for the entirety of a region that does not require use of a low resolution (e.g., a region where the amount of residual positional deviation is not large), resulting in a decline in the accuracy with which the position of a motion region is detected.

In an embodiment, the difference image data generating device executes binarization processing using a binarization threshold value that differs for every divided area. The sensitivity of motion detection can be made different for every divided area.

The registering device may perform the registration of two input images in accordance with global motion, which minimizes overall registration error between two input images, or may perform the registration of two input images in accordance with a motion vector of a specific subject image contained in each of the two input images.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating the electrical configuration of a digital still camera;

FIG. 2 is a flowchart illustrating motion detection processing according to a first embodiment of the present invention;

FIG. 3 illustrates motion detection processing in the form of images according to the first embodiment;

FIG. 4 illustrates an image obtained by superimposing two input images (a reference image and a target image), as well as sizes and directions of amounts of residual positional deviation at a plurality of points;

FIG. 5 is a flowchart illustrating motion detection processing according to a second embodiment of the present invention;

FIG. 6 is a flowchart illustrating motion detection processing according to a third embodiment of the present invention;

FIG. 7 illustrates motion detection processing in the form of images according to the third embodiment;

FIG. 8 illustrates an image obtained by superimposing two input images (a reference image and a target image), sizes and directions of amounts of residual positional deviation at a plurality of points, and divided areas;

FIG. 9 is a flowchart illustrating motion detection processing according to a fourth embodiment of the present invention;

FIG. 10 is a flowchart illustrating motion detection processing according to a fifth embodiment of the present invention; and

FIG. 11 illustrates conventional motion detection processing in the form of images.

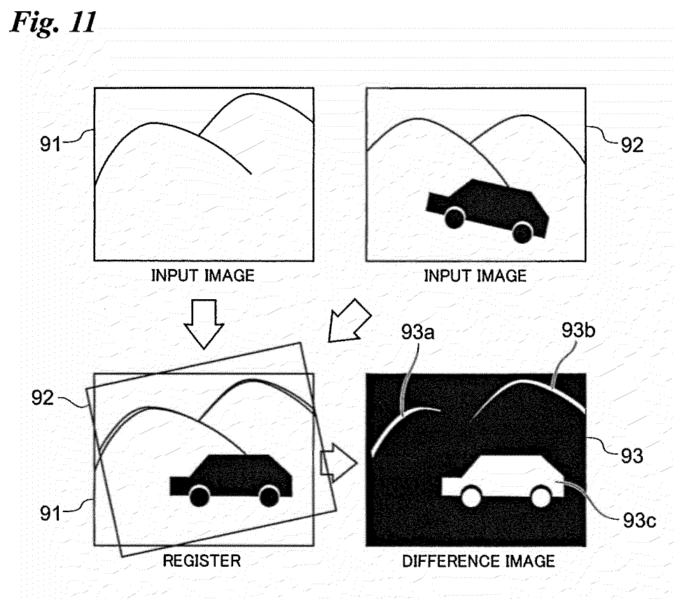

### DESCRIPTION OF THE PREFERRED EMBODIMENTS

Preferred embodiments of the present invention will now be described in detail with reference to the drawings.

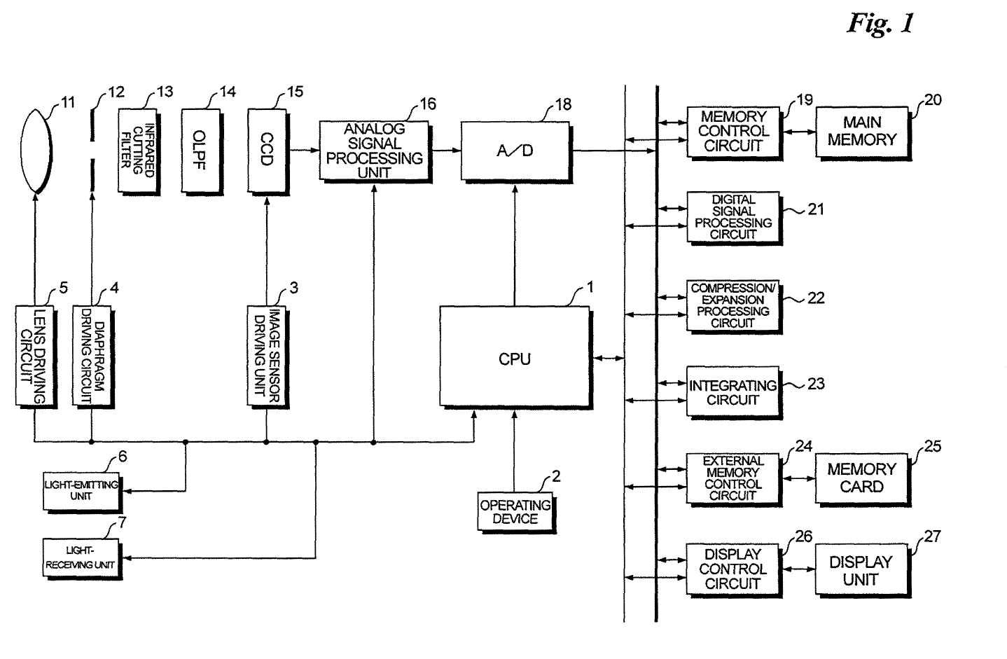

FIG. 1 is a block diagram illustrating the electrical configuration of a digital still camera. The block diagram shown in FIG. 1 is employed not only in a first embodiment but also in second to fifth embodiments described below. Further, the embodiments of the present invention are applicable not only to a digital still camera but also to a digital movie camera.

The overall operation of the digital still camera is controlled by a CPU 1.

The digital still camera is equipped with a CCD 15, and an imaging lens 11, a diaphragm 12, an infrared cutting filter 13 and an optical low-pass filter (OLPF) 14 are provided in front of the CCD 15.

The digital still camera includes an operating device 2. The operating device 2 includes a power button, a mode setting dial and a two-step stroke-type shutter release button, etc. An operating signal that is output from the operating device 2 is input to the CPU 1. A shooting mode and playback mode, etc., are available as modes set by the mode setting dial.

The digital still camera is provided with a light-emitting unit 6 for flash photography and a light-receiving unit 7 for receiving light that is a reflection of the light emitted from the light-emitting device 6.

When the power supply of the digital still camera is turned on and the shooting mode is set, light rays representing the image of the subject impinge upon the imaging lens 11. The light rays impinge upon the photoreceptor surface of the CCD 15 via the imaging lens 11, diaphragm 12, infrared-cutting filter 13 and low-pass filter 14. The image of the subject is formed on the photoreceptor surface of the CCD 15 and an analog signal representing the image of the subject is output from the CCD 15. The subject is imaged at a fixed period by the CCD 15 and a video signal representing the image of the subject at the fixed period is output from the CCD 15 frame by frame.

An analog signal processing unit 16 includes a correlated double sampling circuit and a signal amplifying circuit, etc. An analog signal representing the image of the subject that has been output from the CCD 15 is input to the analog signal processing unit 16 and is subjected to correlated double sampling and signal amplification, etc. The analog video signal that has been output from the analog signal processing unit 16 is input to an analog/digital converting circuit 18 and is converted to digital image data. The digital image data is stored temporarily in a main memory 20 under the control of a memory control circuit 19.

The digital image data is read out of the main memory 20 and is input to a digital signal processing circuit 21. The digital signal processing circuit 21 executes prescribed digital signal processing such as a white balance adjustment and a gamma correction. The data that has been subjected to digital signal processing in the digital signal processing circuit 21 is applied to a display control circuit 26. A display unit 27 is controlled by the display control circuit 26, whereby the image of the subject is displayed on a display screen.

If the shutter-release button is pressed through the first step of its stroke, the lens 11 is driven by a lens driving circuit 5 and focusing is performed. Luminance data is obtained in the digital signal processing circuit 21 based upon image data that has been read out of the main memory 20. The luminance data is input to an integrating circuit 23 and is integrated. Data representing the integrated value is applied to the CPU 1 and the amount of exposure is calculated. The aperture of the diaphragm 12 is controlled by a diaphragm driving circuit 4 and the shutter speed of the CCD 15 is controlled by an image sensor driving circuit 3 in such a manner that the calculated amount of exposure is attained.

If the shutter-release button is pressed through the second step of its stroke, the image data that has been output from the analog/digital converting circuit 18 is similarly recorded in the main memory 20. The image data that has been read out of the main memory 20 is subjected to digital signal processing in a manner similar to that described above. The image data that has been output from the digital signal processing circuit 21 is subjected to data compression in a compression/expansion processing circuit 22. The image data that has been compressed is recorded on a memory card 25 by control performed by an external-memory control circuit 24.

If the playback mode is set, the compressed image data that has been recorded on the memory card 25 is read. The compressed image data read is expanded in the compression/expansion processing circuit 22 and then applied to the display control circuit 26. The reproduced image is displayed on the display screen of the display unit 27.

In this embodiment, the difference between two items of image data is calculated and a subject, namely a moving body, that appears in the difference image can be detected. Positional registration of the two images used in calculating the difference is performed before the difference calculation. Motion detection processing basically is executed by the CPU 1 using the two items of image data, which are stored in main memory 20 temporarily. However, another hardware circuit (e.g., a registering device, a residual positional deviation amount calculating device, etc.) may be made to execute some of this processing. In the description that follows, images represented by two items of image data used in motion detection processing will be referred to as input images 81 and 82.

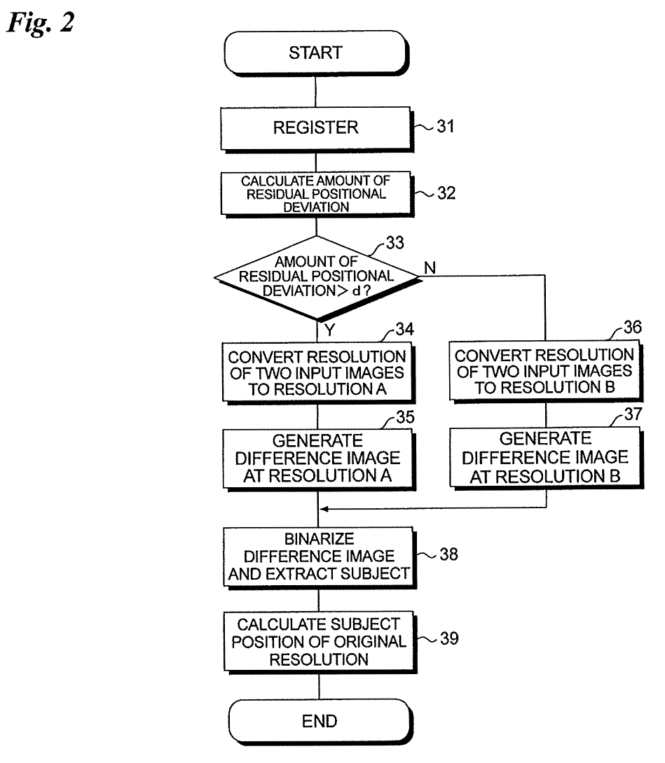

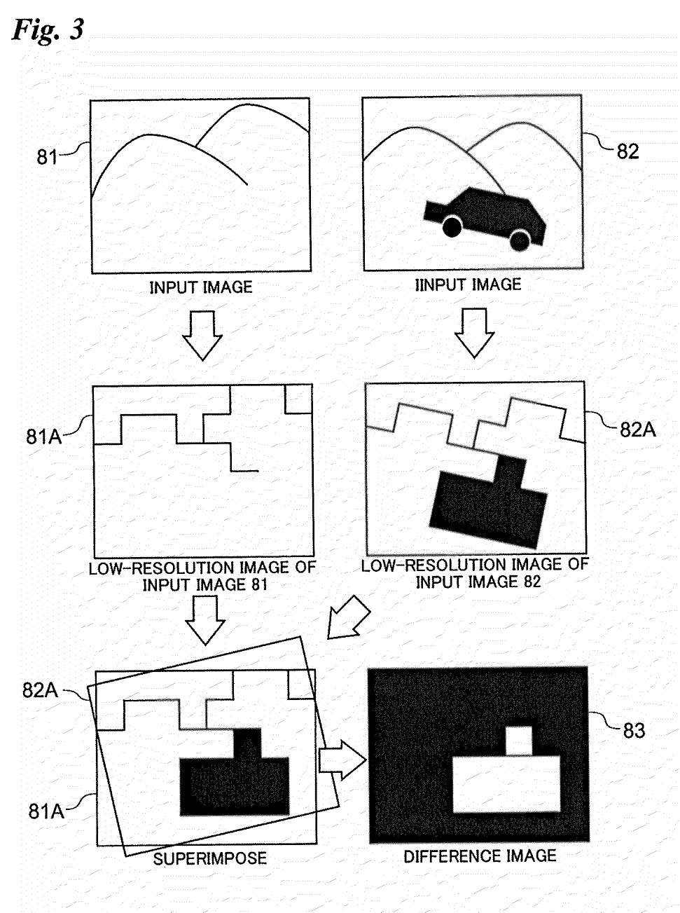

FIG. 2 is a flowchart illustrating motion detection processing according to the first embodiment, and FIG. 3 illustrates motion detection processing of the first embodiment in the form of images.

The two images 81 and 82 represented by the two items of image data that have been stored in the main memory 20 are registered (step 31). In the registering of the two input images 81 and 82, one image (e.g., input image 81) of the two images is adopted as a reference image and the other (input image 82) is adopted as a target image. When this is done, parameters for making the position, inclination and size of the target image 82 conform to the reference image 81 are obtained. A feature regarding a prescribed evaluation criterion point (or region) in the reference image 81 is found, a corresponding point (corresponding region) in the target image 82 having the same feature is searched for and retrieved, the amount of deviation of the corresponding point (region) with respect to the evaluation criterion point (or region) is found to thereby calculate global motion, and this may be adopted as a registration parameter (motion parameter, rotation parameter, enlargement/reduction parameter). A registration parameter may be found by another method as well. In either case, registration parameters for making the position of the target image 82 coincide with the position of the reference image 81 are stored in the main memory 20 temporarily. The relative positional deviation between the two input images 81, 82 is eliminated.

Amount of residual positional deviation is calculated (step 32). Owing to distortion of the lens 11, a change in shooting perspective, accuracy of calculation and limitations of the image deformation algorithm, it is difficult in general to register the two input images 81 and 82 perfectly in terms of the overall images. Consequently, a positional deviation still remains even after registration processing has been applied. In particular, perfect registration of the input images 81, 82 is difficult in the case of images obtained by a digital still camera that is not fixed and used in a non-stationary state.

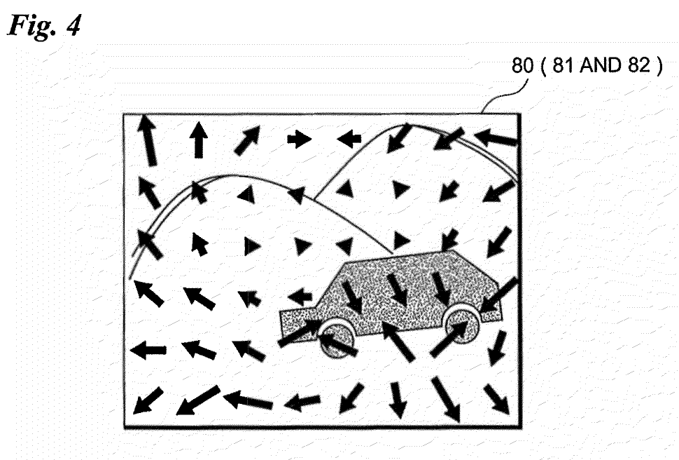

FIG. 4 illustrates, by the directions and lengths of arrows, the sizes and directions of amounts of residual positional deviation at a plurality of corresponding points in a fusion image 80 obtained by superimposing the two input images 81 and 82 after they are registered. In calculating amount of residual positional deviation, corresponding points of the two input images 81, 82 after registration are retrieved and the size (distance) and direction of positional deviation at these corresponding points are calculated. For example, the positional deviation of the largest size is used as the amount of residual positional deviation.

In a case where the amount of residual positional deviation is large, there is a possibility that a difference will occur between the two input images 81 and 83 in a background (still) region. A difference (false positive) will occur in background that is devoid of motion (a moving object) and the originally intended detection (extraction) of a moving body will be hindered.

Accordingly, in this embodiment, processing is executed so as to suppress or eliminate the effects of slight positional deviation by generating low-resolution input images the resolution of which has been made lower than that of the two input images 81, 82, calculating the difference using these images and creating a difference image.

With reference again to FIG. 2, the calculated amount of residual positional deviation and a prescribed threshold value d are compared (step 33). If the calculated amount of residual positional deviation is greater than the threshold value d (“YES” at step 33), then the resolution of the two input images 81, 82 is lowered to a resolution A lower than the original resolution of the two input images 81, 82 (step 34) (see images 81A and 82A in FIG. 3). If the calculated amount of residual positional deviation is equal to or less than the threshold value d (“NO” at step 33), then the resolution of the two input images 81, 82 is lowered to a resolution B lower than the resolution of the two input images 81, 82 and higher than the resolution A (step 36) [the relationship is: (resolution of input images 81, 82)>resolution B>resolution A). In order to arrange it so that resolution will not be lowered unnecessarily, it is desired that the lower resolution A be the highest resolution capable of accommodating the calculated amount of residual positional deviation (the maximum resolution at which corresponding points having a positional deviation equivalent to the amount of residual positional deviation will become the same pixel). Further, the resolutions A and B may both be made to have different horizontal and vertical resolutions. Furthermore, the resolutions A, B need define only two stages; it may be so arranged that multiple stages of resolutions are used. A look-up table storing a plurality of resolutions in correspondence with different amounts of residual positional deviation may be stored in the main memory 20 beforehand, and a resolution conforming to the calculated amount of residual positional deviation may be selected based upon the look-up table.

If the amount of residual positional deviation is greater than the threshold value d, then the two low-resolution input images 81A, 82A having resolution A are obtained. The input image 81A of resolution A and the input image 82A of resolution A are registered based upon the above-mentioned registration parameters that have been stored temporarily in the main memory 20, after which the difference between these images is found to thereby obtain a difference image 83 (step 35). The difference image 83 is binarized by a prescribed threshold value to obtain a binarized difference image. The subject (moving body) is extracted (detected) using the binarized difference image (step 38). The coordinate position (region) of the subject (moving body) in the images having the original resolution may be found as needed (step 39).

If the amount of residual positional deviation is equal to or less than the threshold value d, then processing identical with that described above, except for the fact that two low-resolution images of resolution B are used, is executed (steps 36, 37, 38, 39).

The input images 81A, 82A placed at low resolution are used in creating the difference image 83. Even if slight positional deviation remains in the background (still) region, therefore, either this will not be extracted as a difference or it can be made a very narrow range even if it is extracted. False positives in a still region (background) are suppressed effectively.

In the first embodiment set for above, it is described that both resolutions A and B are lower than the resolution of the input images 81, 82. However, of the resolutions A and B, the resolution B, which is the higher resolution, may be adopted as a resolution identical with that of the input images 81, 82. The same holds true in other embodiments described below.

### Second Embodiment

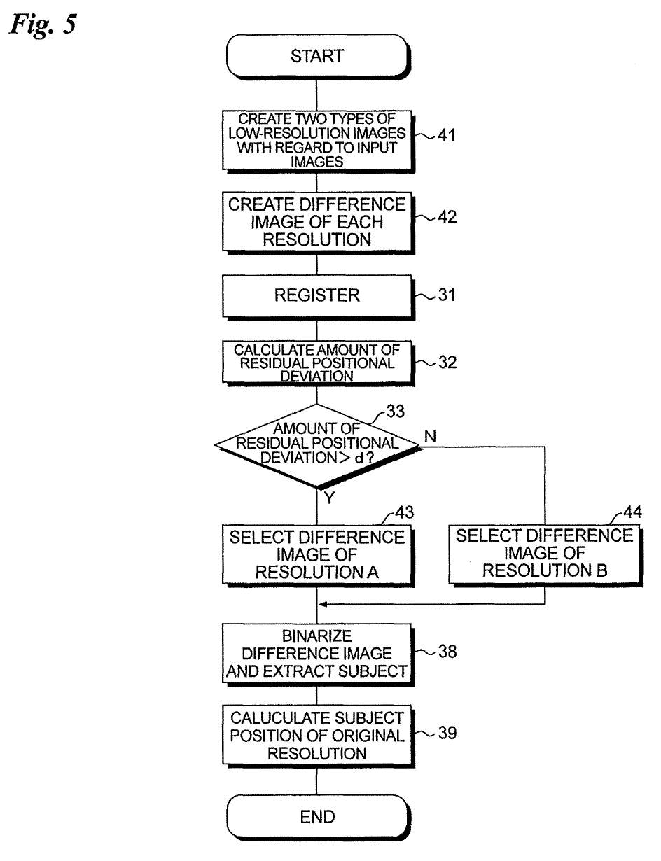

FIG. 5 is a flowchart illustrating motion detection processing according to a second embodiment of the present invention. This flowchart differs from the flowchart of the first embodiment shown in FIG. 2 in that with regard to the input images 81 and 82, low-resolution images 81A, 82A of resolution A, low-resolution images 81B, 82B of resolution B are created beforehand, and a difference image of resolution A calculated from the low-resolution images 81A, 82A and a difference image of resolution B calculated from the low-resolution images 81B, 82B are created (steps 41, 42). The difference image of resolution A and the difference image of resolution B are stored temporarily in the main memory 20.

If the amount of residual positional deviation is greater than the threshold value d, then the difference image of resolution A created beforehand is selected (read out of the main memory 20) (“YES” at step 33; step 43) and the subject (moving body) is extracted from the difference image of resolution A (step 38). If the amount of residual positional deviation is equal to or less than the threshold value d, then the difference image of resolution B created beforehand is selected (read out of the main memory 20) (“NO” at step 33; step 44) and the subject (moving body) is extracted from the difference image of resolution B (step 38).

In the second embodiment as well, the resolution of two input images used in creating a difference image is lower than the resolution of the original input images 81, 82 obtained by imaging. As a result, a false positive in the background (stationary) region is suppressed.

### Third Embodiment

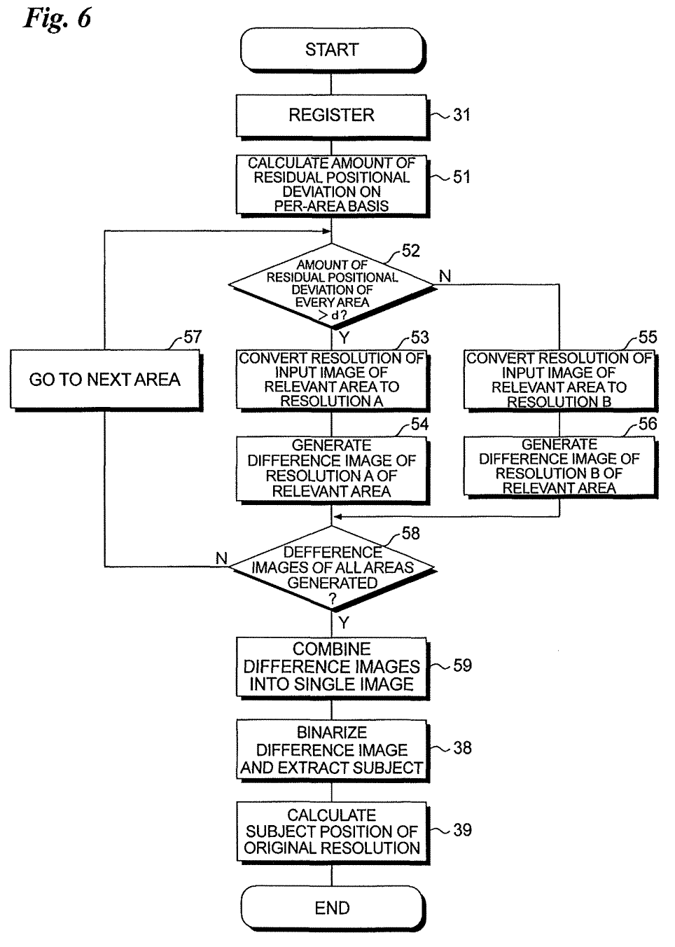

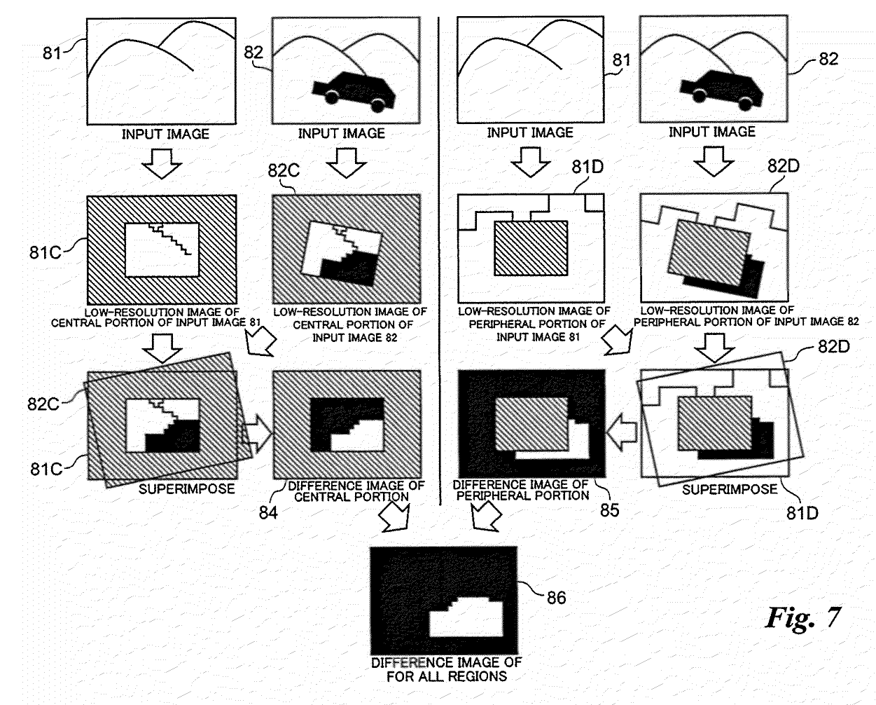

FIG. 6 is a flowchart illustrating motion detection processing according to a third embodiment, and FIG. 7 illustrates motion detection processing of the third embodiment in the form of images.

Motion detection processing according to the third embodiment differs from the processing of the first and second embodiments in that the input images 81, 82 are divided into a plurality of areas and a difference image is created for every divided area. Processing steps in FIG. 6 identical with those of the flowchart (FIG. 2) of motion detection processing of the first embodiment are designated by like step numbers and need not be described again.

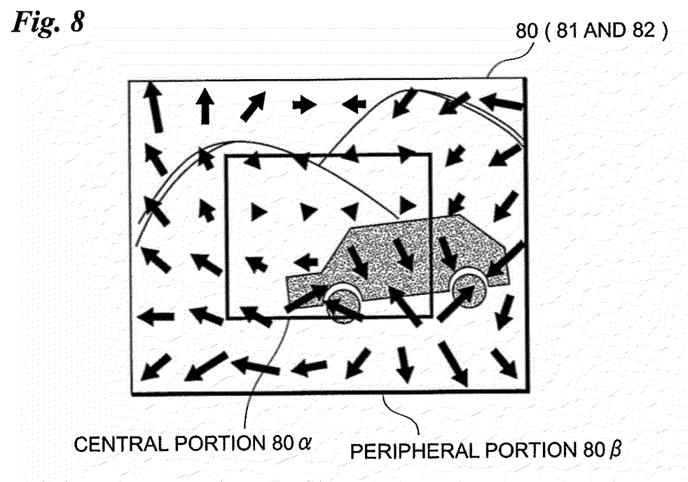

FIG. 8, which corresponds to FIG. 4, illustrates, by the directions and lengths of arrows, the sizes and directions of amounts of residual positional deviation at a plurality of corresponding points in a fusion image 80 obtained by superimposing the two input images 81 and 82 after the registration thereof. FIG. 8 illustrates an example of divided areas as well. The fusion image 80 has been divided into two areas, namely a central area 80α and a peripheral area 80β enclosing the central area 80α. In this case, the above-described motion detection processing of the first embodiment is executed with regard to each of these areas, namely the central area 80α and the peripheral area 80β.

With reference again to FIG. 6, the amount of residual positional deviation for each divided area is calculated (step 51). Specifically, in each of the input images 81, 82, the amount of residual positional deviation is calculated taking only the central area 80α as the target of processing. Similarly, in each of the input images 81, 82, the amount of residual positional deviation is calculated taking only the peripheral area 80β as the target of processing.

With regard to the central area 80α, a difference image 84 is generated upon lowering the resolution of input images 81, 82 so that they will have the resolution A or B (steps 53 and 54 or steps 55 and 56) (see images 81C, 82C, 84 in FIG. 7). Which of the resolutions A and B is employed is based upon whether the amount of residual positional deviation in the central area 80α is greater than the threshold value d (step 52), as described above.

It is determined whether difference images for all areas have been generated (step 58). In a case where a difference image regarding the peripheral area 80β has not been generated, then, with regard to the peripheral area 80β as well, a difference image 85 is generated upon lowering the resolution of input images 81, 82 so that they will have the resolution A or B (step 57, steps 53 and 54 or steps 55 and 56) (see images 81D, 82D, 85 in FIG. 7).

When the two difference images 84 and 85 are generated with regard to the central area 80α and the peripheral area 80β, the two difference images 84, 85 are combined to thereby generate a single difference image 86 (“YES” at step 58; step 59) (see image 86 in FIG. 7). In a manner identical with that of the first embodiment, the generated difference image 86 is binarized by a prescribed threshold value, the subject (moving object) is extracted (detected) using the binarized difference image (step 38), and the coordinate position (region) of the subject (moving body) in the images having the original resolution is found as needed (step 39).

The resolution of the difference image (the resolution of the input images used in creating the difference image) can be changed for every divided area. When divided areas are classified into an area having a small amount of residual positional deviation and an area having a large amount of residual positional deviation, a difference image can be created with regard to the divided area having the small amount of residual positional deviation by using the higher resolution. As a result, the position of the subject (position of the moving body) can be specified with higher accuracy.

It goes without saying that divided areas can be two or greater. Instead of dividing (partitioning) an image into a central area and a peripheral area, grid-like partitioning or some other partitioning method may be employed. The number of divisions and the dividing method is designated by the user using the operating device 2, by way of example.

### Fourth Embodiment

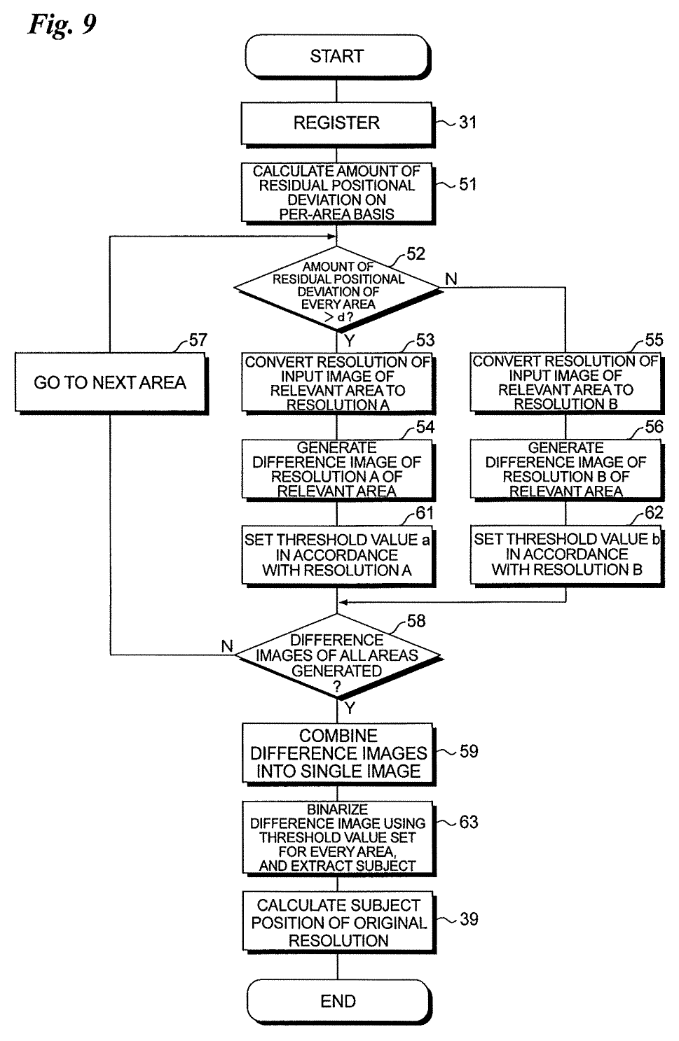

FIG. 9 is a flowchart illustrating motion detection processing according to a fourth embodiment of the present invention. This flowchart differs from the flowchart of the third embodiment shown in FIG. 6 in that the binarization threshold value used in creating the binarized difference images used in detecting the subject (moving body) differs between a value applied to the difference image created using resolution A and a value applied to the difference image creating using the resolution B (steps 61, 62, 63). Processing steps in FIG. 9 identical with those of the flowchart of FIG. 6 are designated by like step numbers and need not be described again.

In subject (moving-body) detection processing, pixels (a region) having a difference value greater than that of a prescribed binarization threshold value in the difference image are detected (extracted) as pixels (a region) representing the subject (moving body). The smaller the binarization threshold value, the higher the sensitivity in terms of subject detection but the greater the incidence of a false positives. Of the difference image having resolution A and the difference image having resolution B, the difference image of resolution A has the lower resolution and therefore is less prone to false positives. In a case where reliable extraction extending up to a moving body exhibiting a small difference is possible by raising the sensitivity of subject detection in a region where there is thus little incidence of false positives, a comparatively small value can be employed as the binarization threshold value applied to the difference image of resolution A (e.g., the threshold value is set to “16” if the range of difference values is 0 to 255 levels), and a larger value can be employed as the binarization threshold value applied to the difference image of resolution B (e.g., the threshold value is set to “32” if the range of difference values is 0 to 255 levels).

On the other hand, an image having a low resolution is more likely to exhibit aliasing due to binarization processing than an image having a high resolution. In a case where reducing the effects of aliasing is the objective, the sensitivity of subject detection should be lowered. For example, since the difference image of the lower resolution A is more prone to aliasing, a comparatively large value may be employed as the applied binarization threshold value (e.g., the threshold value is set to “32” if the range of difference values is 0 to 255 levels), and a smaller value may be employed as the binarization threshold value applied to the difference image of resolution B (e.g., the threshold value is set to “16”).

With reference to FIG. 9, the difference images created for each of the divides areas are combined to thereby obtain a single difference image, after which binarization of the difference image is executed for each divided area. In a case where the difference image of the central area 80α (see image 84 in FIG. 7, and see FIG. 8) has been generated by resolution A, binarization processing is executed using a binarization threshold value a with regard to the zone corresponding to the central area 80α in the single difference image (steps 53, 54, 61, 63). On the other hand, in a case where the difference image of the central area 80α has been generated by resolution B, binarization processing is executed using a binarization threshold value b with regard to the zone corresponding to the central area 80α in the single difference image (steps 55, 56, 62, 63). Similarly, with regard also to the peripheral area 80β in the single difference image, if the difference image of the peripheral area 80β (see image 85 in FIG. 7, and see FIG. 8) has been generated by the resolution A, then binarization processing is executed using the binarization threshold value a (step 63). If the difference image has been generated by the resolution B, then binarization processing is executed using the binarization threshold value b (step 63).

### Fifth Embodiment

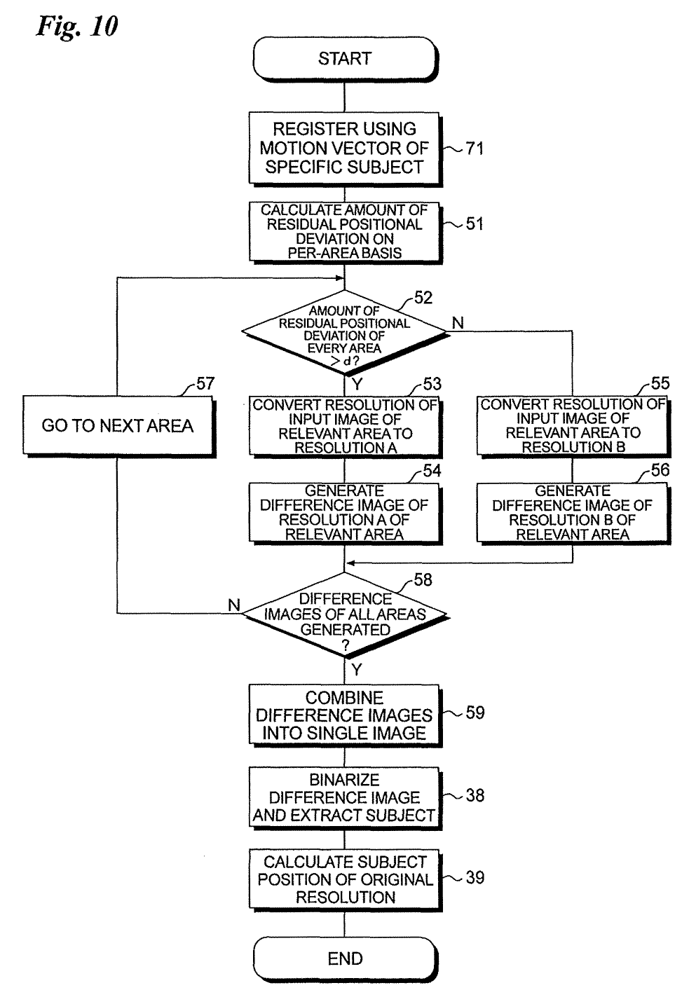

FIG. 10 is a flowchart illustrating motion detection processing according to a fifth embodiment of the present invention. This processing differs from the motion detection processing (FIG. 6) of the third embodiment in that a motion vector of a specific subject is used in registering the two input images 81 and 82 (step 71). Processing steps in FIG. 10 identical with those of the flowchart of FIG. 6 are designated by like step numbers and need not be described again.

By way of example, the face image of a person is detected and the two input images 81, 82 are registered (a motion parameter, rotation parameter, enlargement/reduction parameter are calculated) using the amount of motion and direction (motion vector) thereof of the face image of the person. In comparison with registration using global motion, which minimizes overall image registration error, the overall amount of residual positional deviation in the image is large. With regard to a face image, however, registration can be performed with comparatively high accuracy. By classifying divided areas into a face image and portions other than a face image, the amount of residual positional deviation diminishes with regard to the divided area of the face image and, hence, a difference image having resolution B, which is the higher resolution, is generated (“NO” at step 52; steps 55, 56). The accuracy of motion detection in a case where a face image exhibits motion can be improved.

As many apparently widely different embodiments of the present invention can be made without departing from the spirit and scope thereof, it is to be understood that the invention is not limited to the specific embodiments thereof except as defined in the appended claims.

1. A motion detection apparatus comprising:
an input image data accepting device for accepting input of input image data representing an image within a prescribed imaging target zone obtained by imaging the imaging target zone;
a registering device for registering position of one input image of two input images with position of the other input image so as to eliminate relative positional deviation between the two input images, which are represented by two items of input image data accepted by said input image data accepting device;
a residual positional deviation amount calculating device for calculating amount of residual positional deviation that remains in the two input images after the images are registered by said registering device;
a resolution selecting device for selecting, in accordance with the amount of residual positional deviation, any resolution from among a plurality of resolutions equal to or lower than resolution of the input images;
a low-resolution input image creating device for lowering the resolution of the two input images so that they will take on the selected resolution in a case where a resolution lower than the resolution of the input images has been selected by said resolution selecting device; and
a motion detecting device for detecting a motion region based upon a difference between the two input images or between two low-resolution input images created by said low-resolution input image creating device.

2. The apparatus according to claim 1, wherein the lowest resolution selected by said resolution selecting device from among the resolutions is the highest resolution capable of accommodating the amount of residual positional deviation.

3. The apparatus according to claim 1, wherein said resolution selecting device selects each of a horizontal resolution and a vertical resolution.

4. The apparatus according to claim 1, further comprising a comparing device for comparing the amount of residual positional deviation and a prescribed threshold value;
wherein said resolution selecting device selects the lower resolution of two resolutions that are lower than the resolution of the input images and that have mutually different values in a case where the amount of residual positional deviation exceeds the prescribed threshold value, and selects the higher resolution of these two resolutions in a case where the amount of residual positional deviation is equal to or less than the prescribed threshold value.

5. The apparatus according to claim 1, further comprising a table storing a plurality of resolutions in correspondence with different amounts of residual positional deviation.

6. The apparatus according to claim 1, wherein said motion detecting device detects the motion region from binarized difference image data obtained by comparing and finding the difference between the two input images or between the two low-resolution input images pixel by pixel, and binarizing the difference found.

7. A motion detection apparatus comprising:
an input image data accepting device for accepting input of input image data representing an image within a prescribed imaging target zone obtained by imaging the imaging target zone;
a multiple resolution input image creating device for creating, with regard to a set of two input images represented by two items of input image data accepted by said input image data accepting device, sets of multiple resolution input images having mutually different resolutions equal to or lower than the resolution of the input images;
a difference image data generated device for generating, with regard to each set of multiple resolution input images of mutually different resolutions generated by said multiple resolution input image creating device, difference image data for every set of resolution input images based upon a difference in the set of resolution input images;
a registering device for registering position of one input image of two input images with position of the other input image so as to eliminate relative positional deviation between the two input images, which are represented by two items of input image data accepted by said input image data accepting device;
a residual positional deviation amount calculating device for calculating amount of residual positional deviation that remains in the two input images after the images are registered by said registering device;
a difference image data selecting device for selecting any one of the plurality of items of difference image data, which have been generated by said difference image data generating device, in accordance with the amount of residual positional deviation calculated by said residual positional deviation amount calculating device; and
a motion detecting device for detecting a motion region from the difference image data selected by said image data selecting device.

8. A motion detection apparatus comprising:
an input image data accepting device for accepting input of input image data representing an image within a prescribed imaging target zone obtained by imaging the imaging target zone;
a registering device for registering position of one input image of two input images with position of the other input image so as to eliminate relative positional deviation between the two input images, which are represented by two items of input image data accepted by said input image data accepting device;
an area dividing device for dividing the two input images into a plurality of areas;
a residual positional deviation amount calculating device for calculating, for every divided area, amount of residual positional deviation that remains in the two input images after the images are registered by said registering device;
a resolution selecting device for selecting, for every divided area, in accordance with the amount of residual positional deviation, any resolution from among a plurality of resolutions equal to or lower than resolution of the input images;
a low-resolution input image creating device for lowering the resolution of the divided areas of the two input images so that they will take on the selected resolution in a case where a resolution lower than the resolution of the input images has been selected by said resolution selecting device;
a difference image data generating device for generating difference image data for every divided area based upon a difference in corresponding divided areas of the two input images or in the divided areas of the two low-resolution images created by said low-resolution input image creating device;
a combining device for generating a single item of difference image data by combining the difference image data, of every divided area, generated by said difference image data generating device; and
a motion detecting device for detecting a motion region from the combined difference image data generated by said combining device.

9. The apparatus according to claim 8, wherein said difference image data generating device executes binarization processing using a binarization threshold value that differs for every divided area.

10. The apparatus according to claim 1, wherein said registering device eliminates relative positional deviation between two input images in accordance with global motion that minimizes overall registration error between two input images.

11. The apparatus according to claim 1, wherein said registering device eliminates relative positional deviation between two input images in accordance with a motion vector of a specific subject image contained in each of the two input images.

12. A method of controlling a motion detection apparatus, comprising:
accepting input of input image data representing an image within a prescribed imaging target zone obtained by imaging the imaging target zone;
correcting position of at least either one of the two input images so as to eliminate relative positional deviation between the two images, which are represented by two items of input image data accepted;
calculating an amount of residual positional deviation that remains in the two input images after the images are registered;
selecting, in accordance with the amount of residual positional deviation, any resolution from among a plurality of resolutions equal to or lower than resolution of the input images;
lowering the resolution of the two input images so that they will take on the selected resolution in a case where a resolution lower than the resolution of the input images has been selected; and
detecting a motion region based upon a difference between the two input images or between two low-resolution input images created.

13. A method of controlling a motion detection apparatus, comprising:
accepting input of input image data representing an image within a prescribed imaging target zone obtained by imaging the imaging target zone;
creating, with regard to a set of two input images represented by two items of input image data accepted, sets of multiple resolution input images having mutually different resolutions equal to or lower than the resolution of the input images;
generating, with regard to each set of multiple resolution input images of mutually different resolutions generated, difference image data for every set of resolution input images based upon a difference in the set of resolution input images;
correcting position of at least either one of the two input images so as to eliminate relative positional deviation between the two input images, which are represented by two items of input image data accepted;
calculating amount of residual positional deviation that remains in the two input images after the images are registered;
selecting any one of the plurality of items of difference image data, which have been generated, in accordance with the amount of residual positional deviation calculated; and
detecting a motion region from the difference image data selected.

14. A method of controlling a motion detection apparatus, comprising:
accepting input of input image data representing an image within a prescribed imaging target zone obtained by imaging the imaging target zone;
correcting position of at least either one of the two input images so as to eliminate relative positional deviation between the two input images, which are represented by two items of input image data accepted;
dividing the two input images into a plurality of areas;
calculating, for every divided area, amount of residual positional deviation that remains in the two input images after the images are registered;
selecting, for every divided area, in accordance with the amount of residual positional deviation, any resolution from among a plurality of resolutions equal to or lower than resolution of the input images;
lowering the resolution of the divided areas of the two input images so that they will take on the selected resolution in a case where a resolution lower than the resolution of the input images has been selected;
generating difference image data for every divided area based upon a difference in corresponding divided areas of the two input images or in the divided areas of the two low-resolution images created;
generating a single item of difference image data by combining the generated difference image data of every divided area; and
detecting a motion region from the combined difference image data generated.

15. The apparatus according to claim 7, wherein said registering device eliminates relative positional deviation between two input images in accordance with global motion that minimizes overall registration error between two input images.

16. The apparatus according to claim 8, wherein said registering device eliminates relative positional deviation between two input images in accordance with global motion that minimizes overall registration error between two input images.

17. The apparatus according to claim 7, wherein said registering device eliminates relative positional deviation between two input images in accordance with a motion vector of a specific subject image contained in each of the two input images.

18. The apparatus according to claim 8, wherein said registering device eliminates relative positional deviation between two input images in accordance with a motion vector of a specific subject image contained in each of the two input images.
